(19) United States
(12) Patent Application Publication
(10) Pub. No.: US 2012/0100377 A1
(43) Pub. Date: Apr. 26, 2012

(54) STRESS CRACKING-RESISTANT AND LOW-WARPAGE TWO-COMPONENT MOLDED PARTS COMPRISING TALCUM

(75) Inventors: Andreas Seidel, Dormagen (DE); Eckhard Wenz, Koln (DE); Manfred Nawroth, Wipperfurth (DE); Rainer Protte, Dormagen (DE)

(73) Assignee: BAYER MATERIALSCIENCE AG, Leverkusen (DE)

(21) Appl. No.: 13/119,331

(22) PCT Filed: Sep. 9, 2009
(86) PCT No.: PCT/EP09/06531

§ 371 Date: Apr. 5, 2011

(30) Foreign Application Priority Data
Sep. 20, 2008 (DE) 102008048204.8

(51) Int. Cl. B32B 27/36; B32B 27/32; B29C 45/16

(52) U.S. Cl. 428/412; 264/241; 428/500; 428/523

(57) ABSTRACT

The invention relates to ductile and low-warpage, that is to say dimensionally stable, two-component molded parts which are stress cracking-resistant with respect to the influence of chemicals.

The invention relates to ductile and low-warpage, i.e. dimensionally stable, two-component moulded parts which are stress cracking-resistant with respect to the influence of chemicals, in which an amorphous thermoplastic moulding composition as the first component is back-moulded completely or partially with a second likewise amorphous moulding composition as the second component and a stable material bonding of the second to the first component is achieved.

The invention relates moreover to a process for producing the two-component moulded parts by two-component injection moulding and to the use of the two-component moulded parts as, for example, window or glazing modules in construction and in vehicles, ships or aircraft, in lighting applications, as optical lenses with an injection-moulded surround, in car headlight or rear light applications, in non-transparent decorative components back-moulded two-dimensionally with transparent moulding compositions as a high-gloss layer to obtain an effect of depth, as a (backlightable) screen in cars and as a transparent monitor/display cover with a contrasting (for example opaque or translucent and hence backlightable) surround.

Two-component moulded parts in which a transparent or translucent amorphous material has a stable material bonding to a second amorphous material are already known in principle from various areas of application. Polycarbonate, for example, is used as the transparent or translucent amorphous material of the first component. Polycarbonate, or polycarbonate containing glass fibre-filled compositions, and styrene resin are used as materials of the amorphous second component. Such two-component moulded parts known from the prior art have inadequate ductility and/or inadequate stress cracking resistance with respect to the influence of chemicals and/or strong warpage, i.e. deficient dimensional stability, for many areas of application.

The object of this invention was therefore to provide ductile and low-warpage, i.e. dimensionally stable, two-component moulded parts which are stress cracking-resistant with respect to the influence of chemicals, consisting of an amorphous material as the first component and a second amorphous material as the second component.

Surprisingly it was found that the object of the invention is achieved by two-component moulded parts containing

(i) as a first component an amorphous thermoplastic moulding composition containing
a) 90 to 100 wt. %, preferably 95 to 100 wt. %, particularly preferably 98 to 100 wt. %, in particular 99 to 99.99 wt. % (relative to the sum of components a and b), of amorphous thermoplastic material, preferably selected from at least one of the group consisting of aromatic polycarbonate, aromatic polyester carbonate, polystyrene (co)polymer and polymethyl methacrylate (co)polymer, and
b) 0 to 10 wt. %, preferably 0 to 5 wt. %, particularly preferably 0 to 2 wt. %, in particular 0.01 to 1 wt. % (relative to the sum of components a and b), of at least one commercial polymer additive,
wherein the moulding composition of the first component is free from crystalline or partially crystalline polymeric constituents,
and

(ii) as a second component an amorphous thermoplastic moulding composition consisting of
A) 10 to 100 parts by weight, preferably 60 to 100 parts by weight, particularly preferably 75 to 100 parts by weight, in particular 85 to 95 parts by weight (relative to the sum of components A and B), of at least one component selected from the group consisting of aromatic polycarbonate, aromatic polyester carbonate, polymethyl methacrylate (co)polymer and polystyrene (co)polymer,
B) 0 to 90 parts by weight, preferably 0 to 40 parts by weight, particularly preferably 0 to 25 parts by weight, in particular 5 to 15 parts by weight (relative to the sum of components A and B), of at least one component selected from the group consisting of graft polymer produced by the emulsion polymerisation method, graft polymer produced by the bulk polymerisation method, rubber-free vinyl homopolymer and rubber-free vinyl copolymer,
C) 3 to 30 wt. %, preferably 5 to 22 wt. %, particularly preferably 6 to 15 wt. %, in particular 7 to 12 wt. % (relative to the total composition), of talc, and
D) 0 to 20 wt. %, preferably 0.1 to 15 wt. %, particularly preferably 0.1 to 5 wt. %, in particular 0.2 to 4 wt. % (relative to the total composition), of at least one commercial polymer additive selected from the group consisting of flame retardants and flame retardant synergists, smoke-inhibiting additives, antidripping agents, internal and external lubricants and release agents, flowability auxiliaries, antistatics, conductivity additives, UV stabilisers, heat stabilisers, antioxidants, transesterification inhibitors, hydrolysis stabilisers, antibacterial additives, additives to improve scratch resistance, IR absorbers, optical brighteners, fluorescent additives, impact modifiers, fillers and reinforcing materials differing from component C, as well as dyes and pigments,
wherein the composition of the second component (ii) is free from crystalline or partially crystalline polymeric constituents,
wherein the first component (i) is back-moulded completely or partially with the second component (ii),
wherein the sum of the percentages by weight of components A and B in the total composition of the second component is calculated from the difference between 100 wt. % and the sum of the parts by weight of components C and D, and
wherein the total composition of the second component is understood to be the sum of the percentages by weight of all components A+B+C+D=100 wt. %.

The complete or partial back moulding of the first component (i) with the second component (ii) achieves a bonding of the second component (ii) to the first component (i).

The invention also provides a process for producing the two-component moulded parts by two-component injection moulding, the first component (i) being back-moulded completely or partially with the second component (ii).

In a preferred embodiment
the second component (ii) has an isotropically averaged moulding shrinkage (arithmetic mean of the moulding shrinkage values measured parallel and perpendicular to the melt flow direction) reduced by 10 to 40%, preferably by 12 to 35%, particularly preferably by 13 to 30%, in particular by 13 to 25% in comparison to the first component (i), and
the difference between the moulding shrinkage values for the second component (ii) measured parallel and perpendicular to the melt flow direction is no more than 30%, preferably no more than 20%, particularly preferably no more than 15%, in particular no more than 10% of the arithmetic mean of the moulding shrinkage values for the second component (ii) measured parallel and perpendicular to the melt flow direction.

### First Component (i)

Transparent or translucent amorphous moulding compositions are preferably used as the first component (i).

The preferred constituents a and b of the first component (i) are described below.

### Component a

Aromatic polycarbonates according to component a which are suitable according to the invention are known from the literature or can be produced by methods known from the literature (regarding the production of aromatic polycarbonates see for example Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; regarding the production of aromatic polyester carbonates see for example DE-A 3 077 934).

Aromatic polycarbonates are produced for example by reacting diphenols with carbonic acid halides, preferably phosgene, and/or with aromatic dicarboxylic acid dihalides, preferably benzene dicarboxylic acid dihalides, by the interfacial polycondensation process, optionally using chain terminators, for example monophenols, and optionally using trifunctional or higher-functional branching agents, for example triphenols or tetraphenols. Production via a melt polymerisation process by reacting diphenols with diphenyl carbonate, for example, is also possible.

Diphenols for producing the aromatic polycarbonates and/or aromatic polyester carbonates are preferably those of formula (I)

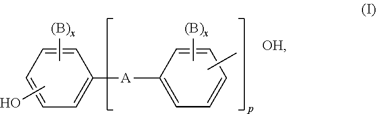

in which
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, to which further aromatic optionally heteroatom-containing rings can be fused,
   or a radical of formula (II) or (III)

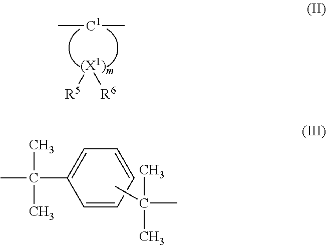

B is in each case C₁ to C₁₂ alkyl, preferably methyl, halogen, preferably chlorine and/or bromine
x is in each case independently 0, 1 or 2,
p is 1 or 0, and
R⁵ and R⁶ can be selected individually for each X¹ and independently of one another denote hydrogen or C₁ to C₆ alkyl, preferably hydrogen, methyl or ethyl,
X¹ denotes carbon and
m denotes a whole number from 4 to 7, preferably 4 or 5, with the proviso that at on least one X¹ atom R⁵ and R⁶ are both alkyl.

Preferred diphenols are hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl)ethers, bis(hydroxyphenyl) sulfoxides, bis(hydroxyphenyl) ketones, bis(hydroxyphenyl) sulfones and α,α-bis(hydroxyphenyl) diisopropyl benzenes and the ring-brominated and/or ring-chlorinated derivatives thereof.

Particularly preferred diphenols are 4,4′-dihydroxydiphenyl, bisphenol A, 2,4-bis-(4-hydroxyphenyl)-2-methylbutane, 1,1-bis-(4-hydroxyphenyl)cyclohexane, 1,1-bis-(4-hydroxyphenyl)-3,3,5-trimethylcyclohexane, 4,4′-dihydroxydiphenylsulfide, 4,4′-dihydroxydiphenylsulfone and the di- and tetrabrominated or chlorinated derivatives thereof, such as for example 2,2-bis-(3-chloro-4-hydroxyphenyl)propane, 2,2-bis-(3,5-dichloro-4-hydroxyphenyl)propane or 2,2-bis-(3,5-dibromo-4-hydroxyphenyl)propane. 2,2-Bis-(4-hydroxyphenyl)propane (bisphenol A) is preferred in particular.

The diphenols can be used on their own or in any combination. The diphenols are known from the literature or can be obtained by methods known from the literature.

Suitable chain terminators for the production of the thermoplastic, aromatic polycarbonates are for example phenol, p-chlorophenol, p-tert-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols having in total 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol %, relative to the molar sum of the individual diphenols used.

The thermoplastic, aromatic polycarbonates have average weight-average molecular weights (M_{w}, measured for example by GPC, ultracentrifuge or light-scattering measurement) of 10,000 to 200,000 g/mol, preferably 15,000 to 80,000 g/mol, particularly preferably 24,000 to 32,000 g/mol.

The thermoplastic, aromatic polycarbonates can be branched in a known manner, and preferably by the incorporation of 0.05 to 2.0 mol %, relative to the sum of diphenols used, of trifunctional or higher-functional compounds, for example those having three or more phenolic groups.

Both homopolycarbonates and copolycarbonates are suitable. For the production of copolycarbonates according to component A of the invention, 1 to 25 wt. %, preferably 2.5 to 25 wt. %, relative to the total amount of diphenols to be used, of polydiorganosiloxanes having hydroxyaryloxy end groups can also be used. These are known (U.S. Pat. No. 3,419,634) and can be produced by methods known from the literature. The production of copolycarbonates containing polydiorganosiloxanes is described in DE-A 3 334 782.

Preferred polycarbonates in addition to the bisphenol A homopolycarbonates are the copolycarbonates of bisphenol A having up to 15 mol %, relative to the molar sums of diphenols, of other diphenols cited as being preferred or particularly preferred, in particular 2,2-bis-(3,5-dibromo-4-hydroxyphenyl)propane.

Aromatic dicarboxylic acid dihalides for the production of aromatic polyester carbonates are preferably the diacid dichlorides of isophthalic acid, terephthalic acid, diphenyl ether-4,4′-dicarboxylic acid and naphthalene-2,6-dicarboxylic acid.

Mixtures of the diacid dichlorides of isophthalic acid and terephthalic acid in the ratio between 1:20 and 20:1 are particularly preferred.

A carbonic acid halide, preferably phosgene, is additionally incorporated in the production of polyester carbonates as a bifunctional acid derivative.

In addition to the monophenols already mentioned, the chloroformic acid esters thereof and the acid chlorides of aromatic monocarboxylic acids, which can optionally be substituted by C₁ to C₂₂ alkyl groups or by halogen atoms, and aliphatic C₂ to C₂₂ monocarboxylic acid chlorides are also suitable as chain terminators for the production of the aromatic polyester carbonates.

The amount of chain terminators in each case is 0.1 to 10 mol %, relative in the case of phenolic chain terminators to mols of diphenol and in the case of monocarboxylic acid chloride chain terminators to mols of dicarboxylic acid dichloride.

The aromatic polyester carbonates can also contain incorporated aromatic hydroxycarboxylic acids.

The aromatic polyester carbonates can be both linear and branched in a known manner (see DE-A 2 940 024 and DE-A 3 007 934 in this respect).

Trifunctional or higher-functional carboxylic acid chlorides, such as trimesic acid trichloride, cyanuric acid trichloride, 3,3′-,4,4′-benzophenone tetracarboxylic acid tetrachloride, 1,4,5,8-naphthalene tetracarboxylic acid tetrachloride or pyromellitic acid tetrachloride, in amounts from 0.01 to 1.0 mol % (relative to dicarboxylic acid dichlorides used), or trifunctional or higher-functional phenols, such as phloroglucinol, 4,6-dimethyl-2,4,6-tri-(4-hydroxyphenyl) hept-2-ene, 4,6-dimethyl-2, 4-6-tri-(4-hydroxyphenyl) heptane, 1,3,5-tri-(4-hydroxyphenyl)benzene, 1,1,1-tri-(4-hydroxyphenyl)ethane, tri-(4-hydroxyphenyl)phenylmethane, 2,2-bis[4,4-bis-(4-hydroxy-phenyl)cyclohexyl]propane, 2,4-bis-(4-hydroxyphenyl isopropyl)phenol, tetra-(4-hydroxyphenyl)methane, 2,6-bis-(2-hydroxy-5-methylbenzyl)-4-methyl phenol, 2-(4-hydroxyphenyl)-2-(2,4-dihydroxyphenyl) propane, tetra-(4-[4-hydroxyphenyl isopropyl]phenoxy)methane, 1,4-bis-[4,4′-dihydroxytriphenyl)methyl] benzene, in amounts from 0.01 to 1.0 mol %, relative to diphenols used, can be used for example as branching agents. Phenolic branching agents can be added with the diphenols, acid chloride branching agents can be introduced together with the acid dichlorides.

The proportion of carbonate structural units in the thermoplastic, aromatic polyester carbonates can vary as required. The proportion of carbonate groups is preferably up to 100 mol %, in particular up to 80 mol %, particularly preferably up to 50 mol %, relative to the sum of ester groups and carbonate groups. Both the ester and the carbonate component of the aromatic polyester carbonates can be present in the form of blocks or be randomly distributed in the polycondensate.

The relative solution viscosity (ηᵣₑₗ) of the aromatic polycarbonates and polyester carbonates is in the range from 1.18 to 1.4, preferably 1.20 to 1.32 (measured in solutions of 0.5 g polycarbonate or polyester carbonate in 100 ml methylene chloride solution at 25° C.).

The thermoplastic, aromatic polycarbonates and polyester carbonates can be used on their own or in any combination.

Polymethyl methacrylate (co)polymers suitable according to the invention as component a are in a preferred embodiment (co)polymers of
a.1) 50 to 100 wt. %, preferably 70 to 100 wt. %, particularly preferably 85 to 100 wt. %, in particular 95 to 100 wt. %, relative to component a, of methyl methacrylate with
a.2) 0 to 50 wt. %, preferably 0 to 30 wt. %, particularly preferably 0 to 15 wt. %, in particular 0 to 5 wt. %, relative to component a, of at least one component selected from the group of alkyl or aryl methacrylates other than methyl methacrylate and/or alkyl or aryl acrylates having C₁ to C₁₀ alkyl, C₅-C₁₀ cycloalkyl or aryl ester radicals, acrylonitrile, methacrylonitrile, acrylamide, methacrylamide, 2-hydroxyethyl (meth)acrylic acid ester, maleic anhydride, maleic acid imides and vinyl aromatics optionally substituted with alkyl and/or halogen, such as for example styrene, p-methylstyrene, α-methylstyrene.

These polymethyl methacrylate (co)polymers are resin-like, thermoplastic and rubber-free.

Pure polymethyl methacrylate is particularly preferred.

Production of the polymethyl methacrylate (co)polymers suitable according to the invention as component a takes place by known means by polymerisation of the monomer(s) in bulk, in solution or in dispersion (Kunststoff-Handbuch, vol. IX, Polymethacrylate, Carl Hanser Verlag Munich 1975, pages 22-37).

Polystyrene (co)polymers suitable according to the invention as component a are in a preferred embodiment (co)polymers of
a.1) 50 bis 100 wt. %, preferably 70 to 100 wt. %, particularly preferably 85 to 100 wt. %, in particular 95 to 100 wt. %, relative to component a, of at least one monomer selected from the group of vinyl aromatics (such as for example styrene, α-methylstyrene) and ring-substituted vinyl aromatics (such as for example p-methylstyrene, p-chlorostyrene), in a preferred embodiment styrene, with
a.2) 0 to 50 wt. %, preferably 0 to 30 wt. %, particularly preferably 0 to 15 wt. %, in particular 0 to 5 wt. %, relative to component a, of at least one monomer selected from the group of vinyl cyanides (such as for example unsaturated nitriles such as acrylonitrile and methacrylonitrile), (meth)acrylic acid (C₁-C₈) alkyl esters (such as for example methyl methacrylate, n-butyl acrylate, tert-butyl acrylate), unsaturated carboxylic acids and derivatives of unsaturated carboxylic acids (for example maleic anhydride and N-phenyl maleinimide).

These styrene (co)polymers are resin-like, thermoplastic and rubber-free.

Pure polystyrene is particularly preferred.

Such styrene (co)polymers are known and can be produced by radical polymerisation, in particular by emulsion, suspension, solution or bulk polymerisation. The styrene (co)polymers preferably have average molecular weights M_{w} (weight-average, determined by GPC, light scattering or sedimentation) of between 15,000 and 250,000.

An aromatic polycarbonate, in particular one based on bisphenol A, is preferably used as component a.

### Component b

The amorphous first component can contain further additives as component b. Suitable further additives according to component b are in particular conventional polymer additives such as flame retardants (e.g. organic phosphorus or halogen compounds, in particular bisphenol A-based oligophosphate, alkali/alkaline-earth or ammonium/phosphonium salts of perfluorinated sulfonic acids), flame retardant synergists and antidripping agents (for example compounds of the substance classes of fluorinated polyolefins, silicones and aramid fibres), smoke-inhibiting additives (for example boric acid or borates), internal and external lubricants and release agents (for example pentaerythritol tetrastearate or glycidyl monostearate), flowability auxiliaries, antistatics, conductivity additives, stabilisers (for example antioxidants, UV stabilisers, transesterification inhibitors, hydrolysis stabilisers, processing stabilisers), IR absorbers, optical brighteners, fluorescent additives, antibacterial additives, additives to improve scratch resistance, impact modifiers (such as for example graft polymers produced by emulsion polymerisation which in a preferred embodiment have a core-shell structure), fillers and reinforcing materials (preferably in extremely fine-particle, in particular nanoscale form, i.e. preferably with a weight-average particle diameter d₅₀ of 1 to 200 nm), as well as dyes and pigments.

### Second Component (ii)

Amorphous moulding compositions are used as the second component (ii). They are preferably opaque, i.e. non-translucent, materials.

The preferred constituents A, B, C and D of the second component (ii) are described below.

### Component A

Component A of the second component (ii) corresponds in its embodiments to component a of the first component (i).

### Component B

Component B is selected from at least one representative from the group of graft polymers B.1 or rubber-free (co)polymers B.2.

Component B.1 comprises one or more graft polymers of
B.1.1 5 to 95, preferably 30 to 90 wt. % of at least one vinyl monomer on
B.1.2 95 to 5, preferably 70 to 10 wt. % of one or more graft bases with glass transition temperatures <10° C., preferably <0° C., particularly preferably <−20° C.

The graft base B.1.2 generally has an average particle size (d₅₀ value) of 0.05 to 10 μm, preferably 0.1 to 5 μm, particularly preferably 0.15 to 2.0 μm.

Monomers B.1.1 are preferably mixtures of
B.1.1.1 50 to 99 parts by weight of vinyl aromatics and/or ring-substituted vinyl aromatics (such as styrene, α-methylstyrene, p-methylstyrene, p-chlorostyrene) and/or methacrylic acid (C₁-C₈) alkyl esters, such as methyl methacrylate, ethyl methacrylate, and
B.1.1.2 1 to 50 parts by weight of vinyl cyanides (unsaturated nitriles such as acrylonitrile and methacrylonitrile) and/or (meth)acrylic acid (C₁-C₈) alkyl esters, such as methyl methacrylate, n-butyl acrylate, t-butyl acrylate, and/or derivatives (such as anhydrides and imides) of unsaturated carboxylic acids, for example maleic anhydride and N-phenyl maleinimide.

Preferred monomers B.1.1.1 are selected from at least one of the monomers styrene, α-methylstyrene and methyl methacrylate, preferred monomers B.1.1.2 are selected from at least one of the monomers acrylonitrile, maleic anhydride and methyl methacrylate. Particularly preferred monomers are B.1.1.1 styrene and B.1.1.2 acrylonitrile.

Suitable graft bases B.1.2 for the graft polymers B.1 are for example diene rubbers, EP(D)M rubbers, in other words those based on ethylene/propylene and optionally diene, acrylate, polyurethane, silicone, chloroprene and ethylene/vinyl acetate rubbers as well as silicone/acrylate composite rubbers.

Preferred graft bases B.1.2 are diene rubbers, based for example on butadiene and isoprene, or mixtures of diene rubbers or copolymers of diene rubbers or mixtures thereof with further copolymerisable monomers (for example according to B.1.1.1 and B.1.1.2), with the proviso that the glass transition temperature of component B.1.2 is <10° C., preferably <0° C., particularly preferably <−20° C. Pure polybutadiene rubber is particularly preferred.

Particularly preferred polymers B.1 are for example ABS polymers (emulsion, bulk and suspension ABS), such as are described for example in DE-OS 2 035 390 (=U.S. Pat. No. 3,644,574) or in DE-OS 2 248 242 (=GB-PS 1 409 275) or in Ullmanns Enzyklopädie der Technischen Chemie, vol. 19 (1980), p. 280 ff.

The graft copolymers B.1 are produced by radical polymerisation, for example by emulsion, suspension, solution or bulk polymerisation, preferably by emulsion or bulk polymerisation, particularly preferably by emulsion polymerisation.

The gel content of graft base B.1.2 is at least 30 wt. % in the case of graft polymers produced by emulsion polymerisation, preferably at least 40 wt. % (measured in toluene).

The gel content of graft polymers B.1 produced by bulk polymerisation is preferably 10 to 50 wt. %, in particular 15 to 40 wt. % (measured in acetone).

Particularly suitable graft rubbers are also ABS polymers produced by means of redox initiation with an initiator system consisting of organic hydroperoxide and ascorbic acid as described in U.S. Pat. No. 4,937,285.

Since it is known that the graft monomers are not necessarily completely grafted onto the graft base during the graft reaction, according to the invention graft polymers B.1 are also understood to include such products which are obtained by (co)polymerisation of the graft monomers in the presence of the graft base and which co-accumulate during preparation. These products can therefore also contain free, i.e. not chemically bonded to the rubber, (co)polymer of the graft monomers.

In the case of graft polymers B.1 produced by bulk polymerisation the weight-average molecular weight M_{w} of the free, i.e. not bonded to the rubber, (co)polymer is preferably 50,000 to 250,000 g/mol, in particular 60,000 to 180,000 g/mol, particularly preferably 70,000 to 130,000 g/mol.

Suitable acrylate rubbers according to B.1.2 are preferably polymers of acrylic acid alkyl esters, optionally with up to 40 wt. %, relative to B.1.2, of other polymerisable, ethylenically unsaturated monomers. The preferred polymerisable acrylic acid esters include C₁-C₈ alkyl esters, for example methyl, ethyl, butyl, n-octyl and 2-ethylhexyl ester; haloalkyl esters, preferably halo C₁-C₈ alkyl esters, such as chloroethyl acrylate, and mixtures of these monomers.

Monomers having more than one polymerisable double bond can be copolymerised for crosslinking. Preferred examples of crosslinking monomers are esters of unsaturated monocarboxylic acids having 3 to 8 C atoms and unsaturated monohydric alcohols having 3 to 12 C atoms, or saturated polyols having 2 to 4 OH groups and 2 to 20 C atoms, such as ethylene glycol dimethacrylate, allyl methacrylate; polyunsaturated heterocyclic compounds, such as trivinyl and triallyl cyanurate; polyfunctional vinyl compounds, such as divinyl and trivinyl benzenes; but also triallyl phosphate and diallyl phthalate. Preferred crosslinking monomers are allyl methacrylate, ethylene glycol dimethacrylate, diallyl phthalate and heterocyclic compounds having at least three ethylenically unsaturated groups. Particularly preferred crosslinking monomers are the cyclic monomers triallyl cyanurate, triallyl isocyanurate, triacryloyl hexahydro-s-triazine, triallyl benzenes. The amount of crosslinked monomers is preferably 0.02 to 5, in particular 0.05 to 2 wt. %, relative to the graft base B.1.2. In the case of cyclic crosslinking monomers having at least three ethylenically unsaturated groups it is advantageous to restrict the amount to less than 1 wt. % of the graft base B.1.2.

Preferred “other” polymerisable, ethylenically unsaturated monomers which can optionally serve to produce the graft base B.1.2 in addition to the acrylic acid esters are for example acrylonitrile, styrene, α-methylstyrene, acrylamides, vinyl C₁-C₆ alkyl ethers, methyl methacrylate, butadiene.

Preferred acrylate rubbers as the graft base B 1.2 are emulsion polymers having a gel content of at least 60 wt. %.

Other suitable graft bases according to B.1.2 are silicone rubbers having graft-active sites, such as are described in DE-OS 3 704 657, DE-OS 3 704 655, DE-OS 3 631 540 and DE-OS 3 631 539.

The gel content of graft base B.1.2 or of graft polymers B.1 is determined at 25° C. in a suitable solvent as the insoluble component in these solvents (M. Hoffmann, H. Krömer, R. Kuhn, Polymeranalytik I and II, Georg Thieme-Verlag, Stuttgart 1977).

The average particle size d₅₀ is the diameter above and below which respectively 50 wt. % of the particles lie. It can be determined by ultracentrifuge measurement (W. Scholtan, H. Lange, Kolloid, Z. and Z. Polymere 250 (1972), 782-1796).

Rubber-free vinyl (co)polymers B.2 are rubber-free homo- and/or copolymers of at least one monomer from the group of vinyl aromatics, vinyl cyanides (unsaturated nitriles), (meth)acrylic acid (C₁ to C₈) alkyl esters, unsaturated carboxylic acids and derivatives (such as anhydrides and imides) of unsaturated carboxylic acids.

Particularly suitable are (co)polymers B.2 consisting of
B.2.1 50 to 99 wt. %, relative to the (co)polymer B.2, of at least one monomer selected from the group of vinyl aromatics (such as for example styrene, α-methylstyrene), ring-substituted vinyl aromatics (such as for example p-methylstyrene, p-chlorostyrene) and (meth)acrylic acid (C₁-C₈) alkyl esters (such as for example methyl methacrylate, n-butyl acrylate, tert-butyl acrylate) and
B.2.2 1 to 50 wt. %, relative to the (co)polymer B.2, of at least one monomer selected from the group of vinyl cyanides (such as for example unsaturated nitriles such as acrylonitrile and methacrylonitrile), (meth)acrylic acid (C₁-C₈) alkyl esters (such as for example methyl methacrylate, n-butyl acrylate, tert-butyl acrylate), unsaturated carboxylic acids and derivatives of unsaturated carboxylic acids (for example maleic anhydride and N-phenyl maleinimide).

These (co)polymers B.2 are resin-like, thermoplastic and rubber-free. The copolymer of styrene and acrylonitrile is particularly preferred.

Such (co)polymers B.2 are known and can be produced by radical polymerisation, in particular by emulsion, suspension, solution or bulk polymerisation. The (co)polymers preferably have average molecular weights M_{w} (weight-average, determined by GPC, light scattering or sedimentation) of between 15,000 and 250,000.

A pure graft polymer B.1 or a mixture of several graft polymers according to B.1, a pure (co)polymer B.2 or a mixture of several (co)polymers according to B.2 or a mixture of at least one graft polymer B.1 and at least one (co)polymer B.2 can be used as component B. If mixtures of several graft polymers, mixtures of several (co)polymers or mixtures of at least one graft polymer and at least one (co)polymer are used, they can be used separately or in the form of a precompound in the production of the compositions according to the invention.

In a preferred embodiment a pure graft polymer B.1 or a mixture of several graft polymers according to B.1 or a mixture of at least one graft polymer B.1 and at least one (co)polymer B.2 is used as component B.

In a particularly preferred embodiment an ABS graft polymer produced by emulsion polymerisation or an ABS graft polymer produced by bulk polymerisation or a mixture of a graft polymer produced by emulsion polymerisation and an SAN copolymer is used as component B.

### Component C

A naturally occurring or synthetically produced talc is used as component C.

Pure talc has the chemical composition 3 MgO.4SiO₂.H₂O and thus an MgO content of 31.9 wt. %, an SiO₂ content of 63.4 wt. % and a content of chemically bonded water of 4.8 wt. %. It is a silicate with a layered structure.

Naturally occurring talc materials generally do not have the ideal composition described above as they are contaminated by partial exchange of the magnesium with other elements, by partial exchange of silicon with aluminium, for example, and/or by intergrowth with other minerals, such as for example dolomite, magnesite and chlorite.

Talc types having a particularly high purity are preferably used as component C. They are characterised by an MgO content of 28 to 35 wt. %, preferably 30 to 33 wt. %, particularly preferably 30.5 to 32 wt. %, and an SiO₂ content of 55 to 65 wt. %, preferably 58 to 64 wt. %, particularly preferably 60 to 62.5 wt. %. Particularly preferred talc types are characterised moreover by an Al₂O₃ content of less than 5 wt. %, particularly preferably less than 1 wt. %, in particular less than 0.7 wt. %.

In particular, the use of talc in the form of finely-ground types having an average particle diameter d₅₀ of <10 μm, preferably <5 μm, particularly preferably <2 μm, most particularly preferably ≦1.5 μm, is advantageous.

The talc can be surface treated, e.g. silanised, in order to ensure a better compatibility with the polymer.

With regard to the processing and production of moulding compositions the use of compacted talc is advantageous.

### Component D

The composition can contain further additives as component D. Suitable further additives according to component D include commercial polymer additives selected from the group consisting of flame retardants (for example phosphorus or halogen compounds), flame retardant synergists (for example nanoscale metal oxides), smoke-inhibiting additives (for example boric acid or borates), antidripping agents (for example compounds of the substance classes of fluorinated polyolefins, silicones and aramid fibres), internal and external lubricants and release agents (for example pentaerythritol tetrastearate, montan wax or polyethylene wax), flowability auxiliaries (for example low-molecular-weight vinyl (co)polymers), antistatics (for example block copolymers of ethylene oxide and propylene oxide, other polyethers or polyhydroxy ethers, polyether amides, polyester amides or sulfonic acid salts), conductivity additives (for example conductive carbon black or carbon nanotubes), stabilisers (for example UV/light stabilisers, heat stabilisers, antioxidants, transesterification inhibitors, hydrolysis stabilisers), antibacterial additives (for example silver or silver salts), additives to improve scratch resistance (for example silicone oils or hard fillers such as (hollow) ceramic beads), IR absorbers, optical brighteners, fluorescent additives, impact modifiers (for example graft polymers with a rubber core, preferably produced by emulsion polymerisation, which in a particularly preferred embodiment have a core-shell structure), fillers and reinforcing materials other than talc (component C) (for example ground glass or carbon fibres, (hollow) glass or ceramic beads, mica, kaolin, CaCO₃ and glass flakes) as well as dyes and pigments (for example carbon black, titanium dioxide or iron oxide). Brønsted acids are excluded from the commercial polymer additives.

Phosphorus-containing compounds are preferably used as the flame retardants according to component D. These are preferably selected from the groups of monomeric and oligomeric phosphoric and phosphonic acid esters, phosphonate amines and phosphazenes, wherein mixtures of several components selected from one or more of these groups can also be used as flame retardants. Other halogen-free phosphorus compounds not specifically mentioned here can also be used alone or in any combination with other halogen-free phosphorus compounds.

Preferred monomeric and oligomeric phosphoric or phosphonic acid esters are phosphorus compounds of the general formula (IV)

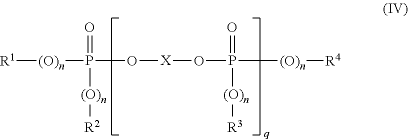

in which
R¹, R², R³ and R⁴ independently of one another denote optionally halogenated C₁ to C₈ alkyl or C₅ to C₆ cycloalkyl, C₆ to C₂₀ aryl or C₇ to C₁₂ aralkyl, each optionally substituted with alkyl, preferably C₁ to C₄ alkyl, and/or halogen, preferably chlorine or bromine,
n independently denotes 0 or 1,
q denotes 0 to 30 and
X denotes a mono- or polynuclear aromatic radical having 6 to 30 C atoms, or a linear or branched aliphatic radical having 2 to 30 C atoms which can be OH-substituted and can contain up to 8 ether bonds.

R¹, R², R³ and R⁴ preferably independently of one another denote C₁ to C₄ alkyl, phenyl, naphthyl or phenyl C₁-C₄ alkyl. The aromatic groups R¹, R², R³ and R⁴ can in turn be substituted with halogen and/or alkyl groups, preferably chlorine, bromine and/or C₁ to C₄ alkyl. Particularly preferred aryl radicals are cresyl, phenyl, xylenyl, propyl phenyl or butyl phenyl and the corresponding brominated and chlorinated derivatives thereof
X in formula (IV) preferably denotes a mono- or polynuclear aromatic radical having 6 to 30 C atoms. This is preferably derived from diphenols of formula (I).
n in formula (IV) can independently be 0 or 1, with n preferably being equal to 1.
q denotes values from 0 to 30, preferably 0.3 to 20, particularly preferably 0.5 to 10, in particular 0.5 to 6, most particularly preferably 1.1 to 1.6.
X particularly preferably denotes

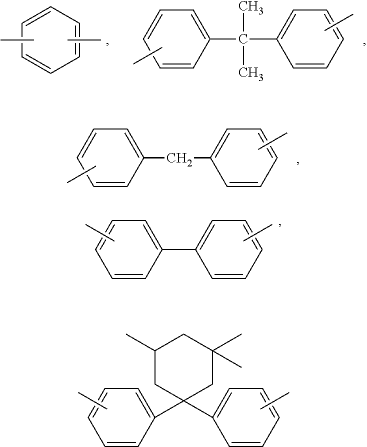

or chlorinated or brominated derivatives thereof, in particular X is derived from resorcinol, hydroquinone, bisphenol A or diphenyl phenol. X is particularly preferably derived from bisphenol A.

Mixtures of various phosphates can also be used as component D according to the invention.

Phosphorus compounds of formula (IV) are in particular tributyl phosphate, triphenyl phosphate, tricresyl phosphate, diphenyl cresyl phosphate, diphenyl octyl phosphate, diphenyl-2-ethyl cresyl phosphate, tri(isopropylphenyl) phosphate, resorcinol-bridged oligophosphate and bisphenol A-bridged oligophosphate. The use of oligomeric phosphoric acid esters of formula (IV) derived from bisphenol A is preferred in particular.

Bisphenol A-based oligophosphate according to formula (IVa) is most preferred as component D.

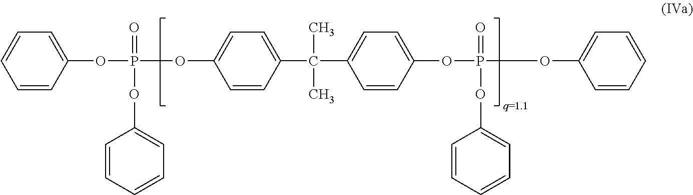

The phosphorus compounds according to component D are known (cf. for example EP-A 0 363 608, EP-A 0 640 655) or can be produced by known methods in an analogous manner (e.g. Ullmanns Enzyklopädie der technischen Chemie, vol. 18, p. 301 ff. 1979; Houben-Weyl, Methoden der organischen Chemie, vol. 12/1, p. 43; Beilstein vol. 6, p. 177).

If mixtures of various phosphorus compounds are used, the specified q value in the case of oligomeric phosphorus compounds is the average q value. The average q value can be determined by determining the composition of the phosphorus compound (molecular weight distribution) by means of a suitable method (gas chromatography (GC), high-pressure liquid chromatography (HPLC), gel permeation chromatography (GPC)) and using this to calculate the average values for q.

Phosphonate amines and phosphazenes as described in WO 00/00541 and WO 01/18105 can also be used as flame retardants.

The flame retardants can be used alone or in any combination with one another or mixed with other flame retardants.

In a preferred embodiment the flame retardants are used in combination with polytetrafluoroethylene (PTFE) as antidripping agent.

The composition of the first component (i) and the second component (ii) is in each case free from crystalline or partially crystalline polymeric constituents; the compositions according to the invention of component (i) and (ii) are in particular free from aromatic or partially aromatic polyesters as disclosed in WO-A 99/28386. Within the meaning of the invention aromatic or partially aromatic polyesters are understood not to be the amorphous polycarbonates which can be used as component a or component A. The aromatic polyesters derive from aromatic dihydroxy compounds and aromatic dicarboxylic acids or aromatic hydroxycarboxylic acids. The partially aromatic polyesters are those based on aromatic dicarboxylic acids and one or more different aliphatic dihydroxy compounds.

### Production of the Moulding Compositions of the First and Second Component

The thermoplastic moulding compositions used as the first and second component can be produced for example by mixing the individual constituents in a known manner and melt-compounding and melt-extruding them at temperatures of 200° C. to 360° C., preferably at 240 to 340° C., particularly preferably at 240 to 320° C., in conventional units such as internal mixers, extruders and twin-shaft screws.

Mixing of the individual constituents can take place in a known manner either successively or simultaneously and both at around 20° C. (room temperature) and at elevated temperature.

### Two-Component Moulded Parts According to the Invention

Production of the low-warpage, i.e. dimensionally stable, ductile two-component parts which are stress cracking-resistant with respect to the influence of chemicals takes place by two-component injection moulding. In this process, after a certain cooling-down time, the transparent or translucent first component is back-moulded completely or partially with the second component, resulting in a stable material bonding of the second to the first component.

These two-component parts can for example be a two-dimensional composite consisting of a transparent or translucent layer with an opaque impact-modified layer, or a composite consisting of a transparent or translucent area framed by an opaque surround. Such composites can be used for example in the windows and glazing sector, in lighting applications, in optical lenses with an opaque injection-moulded surround, in headlight cover discs with an opaque surround, in non-transparent decorative covers back-moulded two-dimensionally with a transparent thermoplastic as a high-gloss layer to obtain an effect of depth, in (backlit) screens in cars and in monitor/display covers with an opaque surround.

Aforementioned two-component parts are preferably produced in a process in which the first component is back-moulded with the second component by injection moulding or injection-compression moulding (two-component injection moulding or two-component injection-compression moulding).

The invention therefore also provides a process for producing the two-component parts according to the invention.

1. Two-component moulded part comprising
(i) as a first component an amorphous thermoplastic moulding composition comprising
a) 90 to 100 wt. % (relative to the sum of components a and b) of amorphous thermoplastic material and
b) 0 to 10 wt. % (relative to the sum of components a and b) of at least one commercial polymer additive,
wherein the moulding composition of the first component is free from crystalline or partially crystalline polymeric constituents,
and
(ii) as a second component an amorphous thermoplastic moulding composition comprising
A) 10 to 100 parts by weight (relative to the sum of components A and B) of at least one component selected from the group consisting of aromatic polycarbonate, aromatic polyester carbonate, polymethyl methacrylate (co)polymer and polystyrene (co)polymer,
B) 0 to 90 parts by weight (relative to the sum of components A and B) of at least one component selected from the group consisting of graft polymer produced by the emulsion polymerisation method, graft polymer produced by the bulk polymerisation method, rubber-free vinyl homopolymer and rubber-free vinyl copolymer,
C) 3 to 30 wt. % (relative to the total composition) of talc, and
D) 0 to 20 wt. % (relative to the total composition) of at least one polymer additive selected from the group consisting of flame retardants and flame retardant synergists, smoke-inhibiting additives, antidripping agents, internal and external lubricants and release agents, flowability auxiliaries, antistatics, conductivity additives, UV stabilisers, heat stabilisers, antioxidants, transesterification inhibitors, hydrolysis stabilisers, antibacterial additives, additives to improve scratch resistance, IR absorbers, optical brighteners, fluorescent additives, impact modifiers, fillers and reinforcing materials differing from component C, dyes and pigments,
wherein the composition of the second component (ii) is free from crystalline or partially crystalline polymeric constituents,
wherein the sum of the percentages by weight of components A and B in the total composition of the second component is calculated from the difference between 100 wt. % and the sum of the parts by weight of components C and D, and
wherein the first component (i) is back-moulded completely or partially with the second component (ii).

2. Two-component moulded part according to claim 1, wherein component a) of the first component (i) is selected from at least one of the group consisting of aromatic polycarbonate, aromatic polyester carbonate, polystyrene (co)polymer and polymethyl methacrylate (co)polymer.

3. Two-component moulded part according to claim 2, wherein component b) of the first component (i) is selected from at least one of the group consisting of flame retardants, flame retardant synergists and antidripping agents, smoke-inhibiting additives, internal and external lubricants and release agents, flowability auxiliaries, antistatics, conductivity additives, stabilisers, IR absorbers, optical brighteners, fluorescent additives, antibacterial additives, additives to improve scratch resistance, impact modifiers, dyes and pigments.

4. Two-component moulded part according to claim 2 comprising 99 to 99.99 wt. % of component a) and 0.01 to 1 wt. % of component b).

5. Two-component moulded part according to claim 2 comprising
A) 60 to 100 parts by weight (relative to the sum of components A and B) of component A),
B) 0 to 40 parts by weight (relative to the sum of components A and B) of component B),
C) 5 to 22 wt. % (relative to the total composition) of component C),
D) 0.1 to 15 wt. % (relative to the total composition) of component D).

6. Two-component moulded part according to claim 5 comprising as component D) a phosphorus compound of formula (IV) 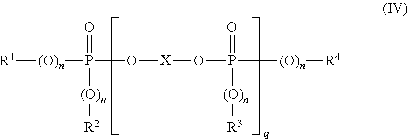
in which
R¹, R², R³ and R⁴ independently of one another denote optionally halogenated C₁ to C₈ alkyl, substituted C₅ to C₆ cycloalkyl, C₆ to C₂₀ aryl or C₇ to C₁₂ aralkyl,
n independently denotes 0 or 1,
q denotes 0 to 30 and
X denotes a mono- or polynuclear aromatic radical having 6 to 30 C atoms, or a linear or branched aliphatic radical having 2 to 30 C atoms which can be OH-substituted and can contain up to 8 ether bonds.

7. Two-component moulded part according to claim 1, wherein a transparent or translucent amorphous moulding composition is used as the first component (i).

8. Two-component moulded part according to claim 7, wherein an opaque moulding composition is used as the second component (ii).

9. Two-component moulded part according to claim 1, wherein
the second component (ii) has an isotropically averaged moulding shrinkage (arithmetic mean of the moulding shrinkage values measured parallel and perpendicular to the melt flow direction) reduced by 10 to 40% in comparison to the first component (i), and
the difference between the moulding shrinkage values for the second component (ii) measured parallel and perpendicular to the melt flow direction is no more than 30% of the arithmetic mean of the moulding shrinkage values for the second component (ii) measured parallel and perpendicular to the melt flow direction.

10. Process for producing the two-component moulded part according to claim 1 by two-component injection moulding, the first component (i) being back-moulded completely or partially with the second component (ii).

11. A window or glazing module in construction and in a vehicle, ship or aircraft, in a lighting application, an optical lens with an injection-moulded surround, a car headlight or rear light application, a non-transparent decorative component back-moulded two-dimensionally with transparent moulding composition as a high-gloss layer to obtain an effect of depth, a screen in cars and/or a transparent monitor/display cover with an opaque surround comprising a two component moulded part of claim 1.
